(19) United States
(12) Patent Application Publication
(10) Pub. No.: US 2008/0069619 A1
(43) Pub. Date: Mar. 20, 2008

(54) Paper Bundle Print System, Method of Controlling Paper Bundle Print System, and Paper Bundle Printer

(75) Inventor: Hiroyasu Kurashina, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 11/852,182

(22) Filed: Sep. 7, 2007

(30) Foreign Application Priority Data
Sep. 20, 2006 (JP) 2006-254775

(51) Int. Cl. B41J 11/58

(52) U.S. Cl. 400/76

(57) ABSTRACT

A paper bundle print system for lifting up and separating paper sheets from a bundle of paper sheets one by one and performing a printing operation on the paper sheet includes: a message acquiring device which acquires a message including a contact name; a storage device which stores the contact name and contact information related to the contact name; a contact name extraction device which extracts the contact name from the message; a contact information acquiring device which acquires the contact information by comparing the extracted contact name with contents of the storage device; and a print device which adds the acquired contact information to the message and performs a printing operation on the paper sheet.

The entire disclosure of Japanese Patent Application No. 2006-254775, filed Sep. 20, 2006, is expressly incorporated by reference herein.

### BACKGROUND

1. Technical Field

The present invention relates to a paper bundle print system for performing a printing operation on paper sheets which are lifted up one by one from a paper bundle, a method of controlling the paper bundle print system, and a paper bundle printer.

2. Related Art

In the related art, a sticky note printer (paper bundle printer) for performing a desired printing operation on a sticky note on the basis of print data prepared by a personal computer connected to a sticky note printer is known (see JP-A-2003-212367).

However, a sticky note may be, for example, used as a telephone message memo. At this time, when the message memo is prepared by a known sticky note printer, information including a contact (a personal name, a company name, a store name or the like), a telephone number or a mail address, and a local time when the contact is in a foreign country should be obtained using the personal computer and be prepared as print data. Accordingly, a user has to prepare the print data by a troublesome process.

### SUMMARY

An advantage of the invention is to provide a paper bundle print system, a method of controlling the paper bundle print system and a paper bundle printer, which are capable of easily preparing print data printed on paper sheets.

According to an aspect of the invention, there is provided a paper bundle print system for lifting up and separating paper sheets from a bundle of paper sheets one by one and performing a printing operation on the paper sheet, the paper bundle print system including: a message acquiring device which acquires a message including a contact name; a storage device which stores the contact name and contact information related to the contact name; a contact name extraction device which extracts the contact name from the message; a contact information acquiring device which acquires the contact information by comparing the extracted contact name with contents of the storage device; and a print device which adds the acquired contact information to the message and performs a printing operation on the paper sheet.

According to another aspect of the invention, there is provided a method of controlling a paper bundle print system for lifting up and separating paper sheets from a bundle of paper sheets one by one and performing a printing operation on the paper sheet, the method including: acquiring a message including a contact name; storing the contact name and contact information related to the contact name; extracting the contact name from the message; acquiring the contact information by comparing the extracted contact name with contents of the storage device; and adding the acquired contact information to the message and performing a printing operation on the paper sheet.

According to this configuration, when the contact name is included in the prepared message, the contact name extraction device extracts the contact name, the contact information acquiring device acquires the contact information corresponding to the contact name from the storage device on the basis of the extracted contact name, and the print device automatically prints the contact information together with the message. That is, since a user prepares only the message such that the contact information related to the contact name is automatically added, it is possible to reduce time and effort of the user required for preparing the contact information related to the contact name as print data. The contact name may include a personal name, a company name or a store name. The bundle of paper sheets may include a memo pad or a bundle of sticky notes.

According to another aspect of the invention, there is provided a paper bundle print system for lifting up and separating paper sheets from a bundle of paper sheets one by one and performing a printing operation on the paper sheet, the paper bundle print system including: a contact acquiring device which acquires a contact name; a message acquiring device which acquires a message; a storage device which stores the contact name and contact information related to the contact name; a contact information acquiring device which acquires the contact information from the storage device on the basis of the acquired contact name; and a print device which adds the acquired contact information and the contact name to the message and performs the printing operation on the paper sheet.

According to another aspect of the invention, there is provided a method of controlling a paper bundle print system for lifting up and separating paper sheets from a bundle of paper sheets one by one and performing a printing operation on the paper sheet, the method including: acquiring a contact name; acquiring a message; storing the contact name and contact information related to the contact name; acquiring the contact information from a storage device on the basis of the acquired contact name; and adding the acquired contact information and the contact name to the message and performing the printing operation on the paper sheet.

According to this configuration, the contact information acquiring device acquires the contact information corresponding to the contact name from the storage device on the basis of the acquired contact name, and the print device automatically prints the contact information together with the contact name and the message. That is, since a user prepares only the contact name and the message such that the contact information related to the contact name is automatically added, it is possible to reduce time and effort of the user required for preparing the contact information related to the contact name as print data.

In this case, the contact information may include at least one of a telephone number, a mail address, an address, a time difference between a local time of the address and a current time of the printing operation on the paper sheet.

According to this configuration, since the telephone numbers the mail address, or the time difference is printed on the printed sticky note together with the message, the user does not need to prepare the contact information as the print data. Since a recipient who receives this sticky note can easily know the telephone number, the mail address and the time difference of the contact, the recipient can rapidly give a call without searching for the telephone and cope with the local time of the contact on the basis of the time difference of the contact. Instead of the time difference, the local time may be displayed.

In this case, the paper bundle print system may further include a common expression storage device which stores a plurality of common expressions relating to the message; and a common expression selection device which selects at least a desired common expression from the common expression storage device.

According to this configuration, since the common expression selection device selects a desired common expression and uses the common expression as the message, it is possible to reduce time and effort required for preparing the message and to more easily prepare the print data.

In this case, the paper bundle print system may further include a common expression registration device which registers a new common expression in the common expression storage device.

According to this configuration, since the common expression which is in general use can be newly registered, it is possible to improve general versatility of the paper bundle print system.

In this case, the print bundle print system may include a paper bundle printer including the print device; and a computer including the message acquiring device, the storage device, the contact name extraction device and the contact information acquiring device.

According to this configuration, it is possible to automatically add the contact information related to the contact name to the message using the computer on the basis of the extracted contact name and to perform a printing operation.

In this case, the print bundle print system may include a paper bundle printer including the print device; and a computer including the contact acquiring device, the message acquiring device, the storage device, and the contact information acquiring device.

According to this configuration, it is possible to automatically add the contact information related to the contact name to the message using the computer on the basis of the acquired contact name and to perform the printing operation.

According to another aspect of the invention, there is provided a paper bundle printer including all the devices of the paper bundle print system.

According to this configuration, it is possible to automatically add the contact information related to the contact name to the message using a paper bundle printer as a single body, on the basis of the extracted or acquired contact name, and to perform the printing operation.

### BRIEF DESCRIPTION OF THE DRAWING

The invention will be described with reference to the accompanying drawings, wherein like numbers reference like elements.

FIG. 1 is a schematic view showing a sticky note print system according to an embodiment of the invention.

FIG. 2 is an appearance perspective view showing a sticky note printer according to the embodiment of the invention.

FIG. 3 is an internal schematic view showing the sticky note printer according to the embodiment of the invention.

FIG. 4 is a schematic view showing an EDIT screen of application software.

FIG. 5 is a schematic view showing a DATA screen of the application software.

FIG. 6 is a schematic view showing a contact data registration screen of the application software.

FIG. 7 is a schematic view showing a JOB screen of the application screen.

FIG. 8 is a schematic view showing a telephone memo preparation screen of the application software.

FIG. 9 is a view showing a sticky note prepared on the telephone memo preparation screen.

FIG. 10 is a flowchart showing a series of operations for adding contact information and performing a printing operation on a sticky note.

FIG. 11 is a schematic view showing an EDIT screen of application software according to a second embodiment of the invention.

FIG. 12 is a flowchart showing a series of operations for adding contact information and performing a printing operation on a sticky note according to the second embodiment.

FIG. 13 is a schematic view showing an EDIT screen of application software according to a modified example.

### DESCRIPTION OF EXEMPLARY EMBODIMENTS

Hereinafter, a sticky note print system (paper bundle print system) according to an embodiment of the invention will be described with reference to the accompanying drawings. In the sticky note print system, an uppermost sticky note is lifted up from a bundle of sticky notes (a bundle of paper sheets) held in a sticky note printer (paper bundle printer), a printing operation is performed on the basis of print data prepared by a personal computer while the turned-up sticky note being separated, and a sticky note on which the printing operation has been performed is ejected to outside of the device.

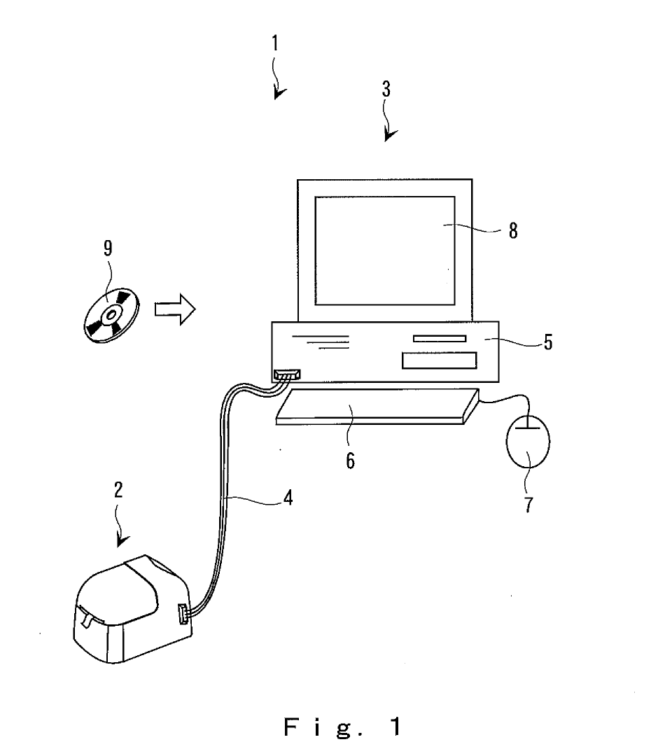

As shown in FIG. 1, the sticky note print system 1 includes a sticky note printer 2 in which a sticky note bundle H is held and a personal computer 3, which is connected to the sticky note printer 2 via a USB cable 4, for preparing and editing print data which will be printed on a sticky note H1 and controlling a variety of driving operations of the sticky note printer 2.

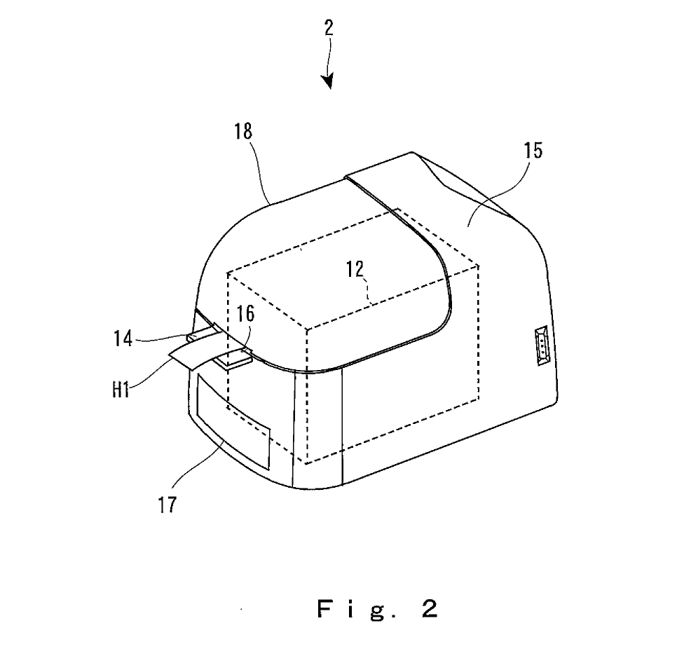

As shown in FIG. 2, the sticky note printer 2 includes a device casing 15 configuring an outer shell and a print unit assembly (print device) 12 for performing the printing operation while separating a sticky note H1 from the sticky note bundle H held in the device casing 15.

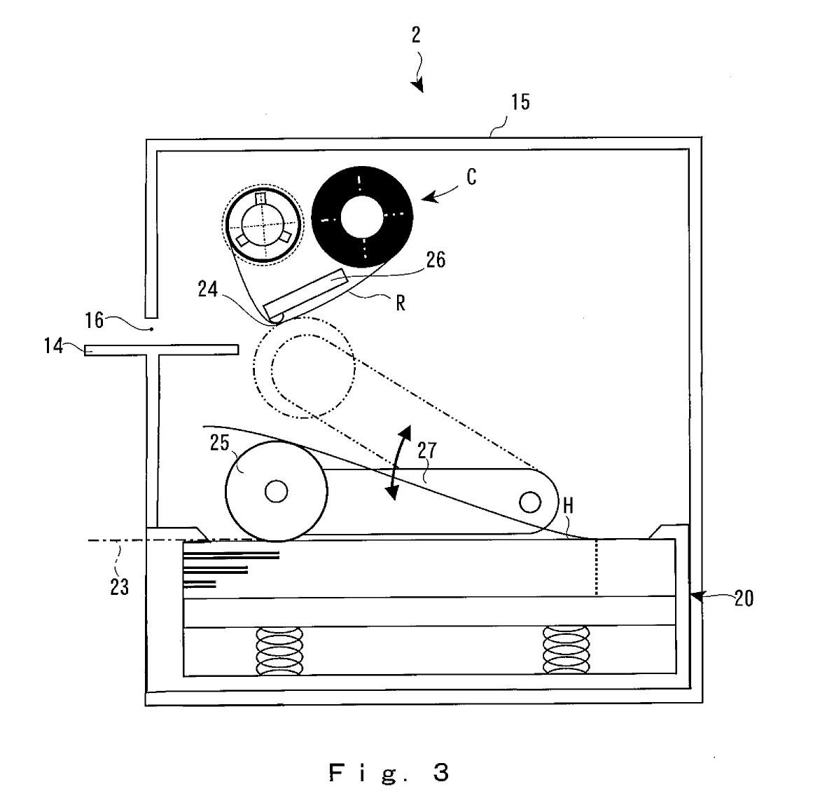

The sticky note bundle H1 is formed by laminating a plurality of rectangular sticky notes H1, the base end of the rear surface of each of which is partially pasted (see FIG. 3). The sticky notes H1 can be separated from the sticky note bundle H one by one and can be adhered to a notebook via the pasted portion of the base end thereof after separation.

The device casing 15 is formed in a small size. A cassette insertion opening 17 allowing insertion of a sticky note cassette 20 from the front side of the device casing 15 into the casing of a draw-out type is formed in the lower portion of the front surface of the device casing 15. A horizontal-slit-shaped ejection slot 16 for ejecting the sticky note H1, on which the printing operation has been performed, to outside of the device casing 15 and a reception portion 14, which extends from the inside of the device casing 15 to the outside of the device casing 15 with the ejection slot 16 as a boundary therebetween, for receiving the sticky note H1 on which the printing operation has been performed, are formed in the central portion of the front surface of the device casing 15. A ribbon cartridge C is mounted and an openable cover 18 for allowing maintenance is attached on the upper surface of the device casing 15.

As shown in FIG. 3, the print unit assembly 12 includes the sticky note cassette 20 for holding the sticky note bundle H, a pickup roller 25 for lifting up an uppermost sticky note H1 of the sticky note bundle H held therein at a lift-up position 23, separating the sticky note H1, and ejecting the sticky note H1, a thermal head 26 for performing the printing operation on the sticky note H1 fed by the pickup roller 25, and a roller arm 27 for moving the pickup roller 25 between the lift-up position 23 and a print position 24 where the pickup roller 25 contacts the thermal head 26, and the ribbon cartridge C for receiving an ink ribbon R. That is, the pickup roller 25 also functions as a platen roller which faces the thermal head 26.

In the print unit assembly 12, with respect to the sticky note bundle H held in the sticky note cassette 20, the pickup roller 25 approaches the lift-up position 23, an uppermost sticky note H1 is lifted up, and the pickup roller 25 is moved to the print position 24 by the roller arm 27 in this state. Then, the pickup roller 25 which is moved to the print position 24 inserts the turned-up sticky note H1 and the ink ribbon R, which is continuously paid out from the mounted ribbon cartridge C, between the thermal head 25 and the pickup roller 25 and feeds the sticky note H1 toward the ejection slot 16. The ink of the ink ribbon R is thermally transferred on the fed sticky note H1 by the thermal head 26.

As shown in FIG. 1, the personal computer 3 includes a personal computer body 5, a keyboard 6 and mouse 7, which are connected to the personal computer body 5 so as to allow input of data, and a display 8 for displaying result of an input. In the personal computer body 5, a CD-ROM 9 for storing data such as a device driver or application software of the sticky note printer 2 is detachably set. When a variety of detection signals, a variety of instructions, or a variety of data is input via the keyboard 6, the personal computer 3 processes the variety of data according to a program stored in the CD-ROM 9 to control the sticky note printer 2.

That is, when a message is printed on the sticky note H1, first, application software 30 starts up on the personal computer 3. Next, print data is prepared using the application software 30 and, when a print button 31 is clicked, the sticky note printer 2 performs the printing operation on the sticky note H1 on the basis of the prepared print data and the sticky note H1 on which the printing operation has been performed is ejected toward the ejection slot 16.

A function for preparing and editing print data, a function for controlling each unit or the display 8 may be provided in the sticky note printer 2 such that the printing operation is performed on the sticky note H1 using the sticky note printer 2 as a stand-alone.

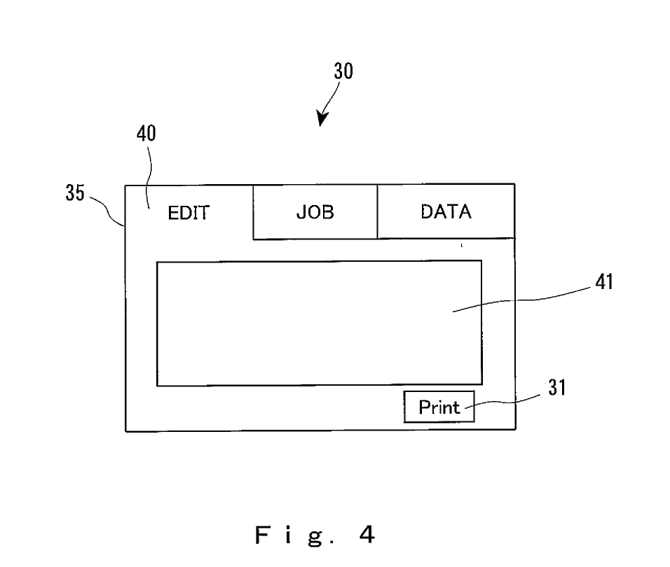

Now, the application software 30 will be described in detail with reference to FIG. 4. The application software 30 includes an EDIT screen 35 which is a default screen shown upon start-up, a JOB screen 36 for preparing the print data on the basis of registered registration data, and a DATA screen 37 for editing the registration data. The screens 35, 36 and 37 are arranged in a layered manner.

The EDIT screen 35 has an EDIT tab 40 which protrudes at the upper side of the EDIT screen 35, for allowing selection of the EDIT screen, a message input region 41 which is provided in substantially the entirety of the EDIT screen 35, for inputting a message 57 using the keyboard 6 and displaying the message, and the print button 31 which is provided at the right lower side of the EDIT screen 35, for instructing printing of the message displayed in the message input region. That is, the message 57 input to the message input region 41 is acquired by a message acquiring device of the application software 30 and, when the print button 31 is clicked, the message 57 is printed on the sticky note H1 on the basis of the acquired message 57.

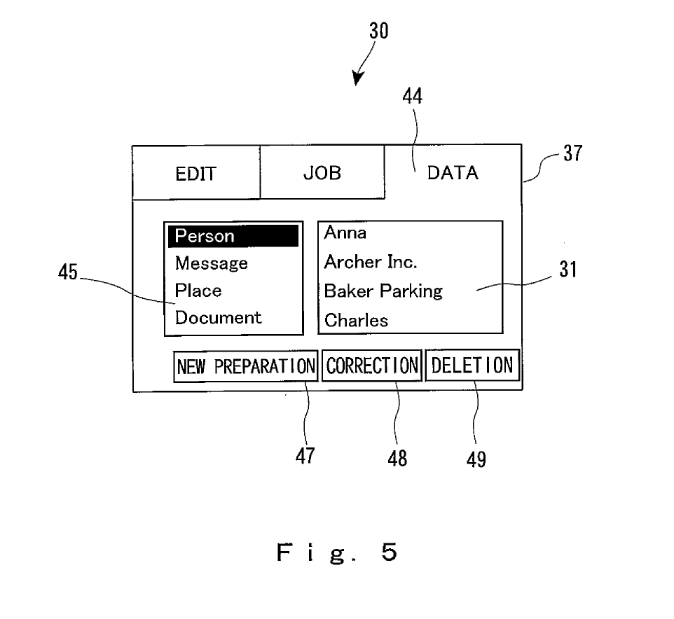

As shown in FIG. 5, the DATA screen 37 includes a DATA tab 44 which protrudes at the upper side of the DATA screen 37, for selecting the DATA screen 37, a category selection region 45 which is provided at the left side of the DATA screen 37, for displaying a plurality of categories such that any category can be selected, a data edit region 46 which is provided at the right side of the DATA screen 37, for displaying a plurality of registration data corresponding to the category selected by the category selection region 45 such that any data can be selected, a new preparation button 47 which is provided at the left lower side of the DATA screen 37, for instructing preparation and registration of new registration data in the selected category, a correction button 48 which is provided at the central lower side of the DATA screen 37, for instructing of correction the registration data, and a deletion button 49 which is provided at the right lower side of the DATA screen 37, for instructing deletion of the registration data.

The category selection region 45 includes “Person”, “Message”, “Place” and “Document” as the plurality of categories. When each category is selected, the registration data corresponding thereto is displayed in the data edit region 46. That is, when the category “person” is selected, a plurality of contact names 55 including personal names, company names and store names are displayed in the data edit region 46 and, when the category “Message” is selected, a plurality of common expressions which are in general use are displayed in the data edit region 46. When the category “Place” is selected, a plurality of place names are displayed in the data edit region 46 and, when the category “Document” is selected, a plurality of document names are displayed in the data edit region 46.

The registration data of each category selected in the category selection region 45 is displayed in the data edit region 46. For example, when the category “Person” is selected in the category selection region 45, the plurality of contact names, that is, the personal names and the company names such as “Anna” and “Archer Inc.” and so on are displayed in the data edit region 46.

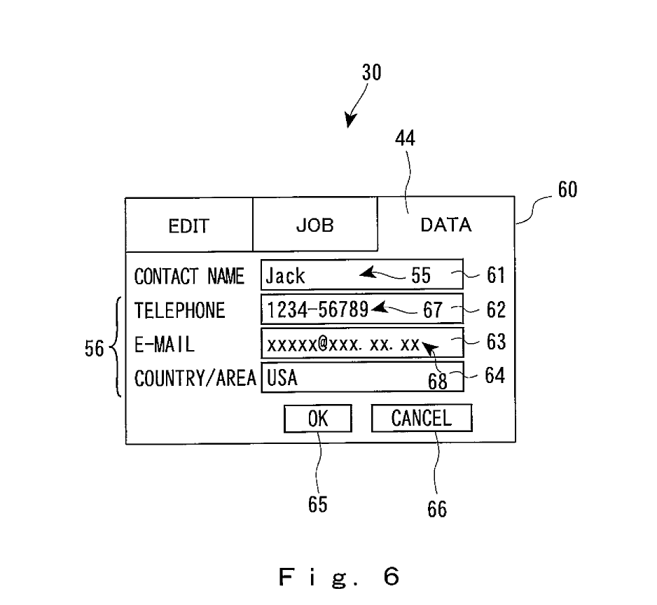

The new preparation button 47 is for instructing preparation and registration of new registration data in the selected category. For example, when the new preparation button 47 is clicked in a state that the category “Person” is selected, a contact data registration screen 60 for registering contact data as the registration data is displayed (see FIG. 6). That is, the registration data varies according to the category. In a storage unit (storage device) of the personal computer, contact data is stored in a case of the category “Person”, common expression data is stored in a case of the category “Message”, place data is stored in a case of the category “Place”, and document data is stored in a case of the category “Document”.

As shown in FIG. 6, the contact data registration screen 60 is for registering a contact name 55 and contact information 56 associated therewith and has an contact name input region 61 into which the contact name 55 is input, a telephone number input region 62 into which a telephone number 67 of the contact is input, a mail address input region 63 into which a mail address 68 of the contact is input, and a country/area input region 64 into which a country/area of the contact (address location) is input. An OK button 65 and a cancel button 66 are provided at the lower side of the contact data registration screen 60.

When the new preparation button 47 is clicked, the contact data registration screen 60 is displayed and desired data is input to the input region using the keyboard 6. When the input is completed and the OK button 65 is clicked, new contact data is registered on the basis of the input data.

The correction button 48 is for instructing reediting of the registered data. For example, when the correction button 48 is clicked in a state that “Person” of the category selection region 45 is selected and “Anna” of the data edit region 46 is selected, the contact data registration screen 60 of “Anna” is displayed and the contact data of “Anna” can be reedited.

The deletion button 49 is for instructing deletion of the registered data. For example, when the deletion button 49 is clicked in a state that “Person” of the category selection region 45 is selected and “Anna” of the data edit region 46 is selected, the contact data of “Anna” is deleted.

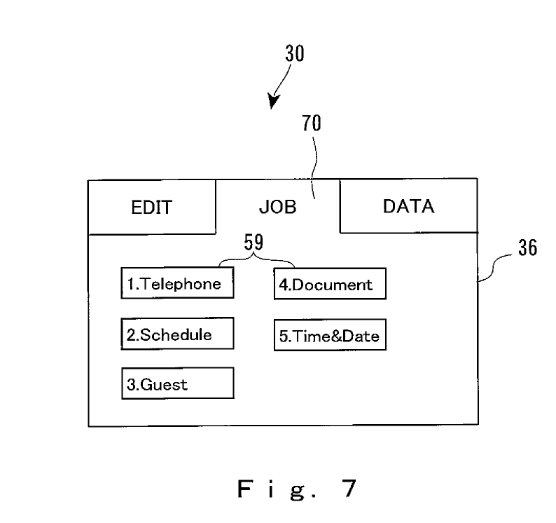

As shown in FIG. 7, the JOB screen 36 includes a JOB tab 70 which protrudes at the upper side of the JOB screen 36, for allowing selection of the JOB screen 36, and a plurality of JOB buttons 59 which are arranged on the JOB screen 36 in a matrix to divide the messages 57 printed on the sticky note H1 according to the use thereof. That is, the JOB buttons 59, for example, include “Telephone”, “Schedule”, “Guest”, “Document”, “Time&Date” and so on. When “Telephone” is selected, a telephone memo may be prepared and, when “Schedule” is selected, a schedule memo may be prepared. “Guest” is used to prepare a guest memo, “Document” is used to prepare a memo output on a document, and “Time&Date” is used as a time stamp such as a date or a time. For example, a case of preparing the telephone memo on the JOB screen 36 will be described.

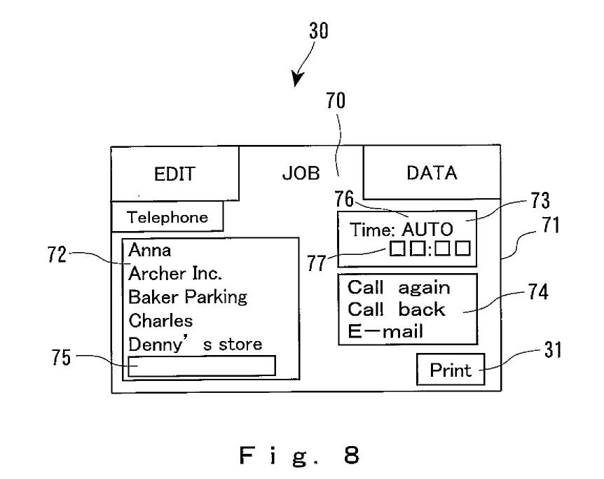

As shown in FIG. 8, when “Telephone” displayed on the JOB screen 36 is clicked, a telephone memo preparation screen 71 is displayed. The telephone memo preparation screen 71 includes a contact selection region 72 which is provided at the left side of the screen, for displaying a contact of a calling party and allowing selection thereof, a time selection region 73 which is provided at the right upper side of the screen, for displaying and allowing selection of a current time 81 or a desired time, a message selection region 74 which is provided at the right lower side, for displaying and allowing selection of a message, and the print button 31 for instructing performance of the printing operation on the basis of the selection.

The contact selection region 72 displays the contact name 55 of the registered contact data on the DATA screen 37. A contact input region 75 which can be used to freely input the contact name 55 is provided at the lower side of the contact selection region 72. That is, when the registered contact name 55 does not exist, the contact name 44 is input to the contact input region 75 such that any contact name 55 can be printed on the sticky note H1. When the contact name 55 is input, the contact name 55 is acquired by the contact acquiring device of the application software 30 and the contact name 55 is printed on the sticky note H1 on the basis of the acquired contact name 55.

The time selection region 73 has a current time option 76 for performing the printing operation on the sticky note at the current time 81 and a time input option 77 for inputting a desired time for performing the printing operation on the sticky note H1. When a telephone is answered and a telephone memo is immediately prepared, the current time option 76 is selected such that a time at which the telephone was answered can be printed on the sticky note H1. When the telephone is answered and a telephone memo is prepared after lapse of time, the time input option 77 is selected and the time at which the telephone was answered is input such that the time at which the telephone was answered can be printed on the sticky note.

The message selection region 74, for example, includes options including “Call again”, “Call back” and “E-mail”. When “Call again” is selected, a message “Call again” is printed on the sticky note, when “call back” is selected, a message “call back” is selected, a message “Call back” is printed on the sticky note H1, and, when “E-mail” is selected, a message “Send e-mail” is printed on the sticky note.

In order to prepare the telephone memo, the telephone memo preparation screen 71 is displayed and the contact name 55 displayed in the contact selection region 72 is selected. Thereafter, the current time option 76 is selected in the time selection region 73 and “Call back” is selected in the message selection region 74. When the print button 31 is clicked after all selections has been completed, the printing operation is performed on the sticky note H1 on the basis of the selection.

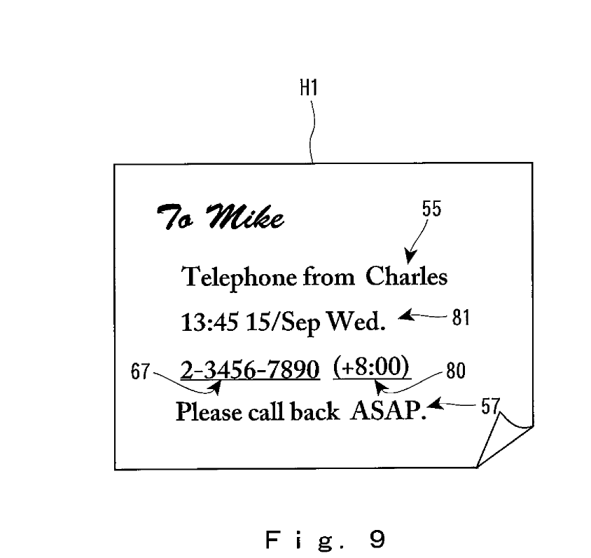

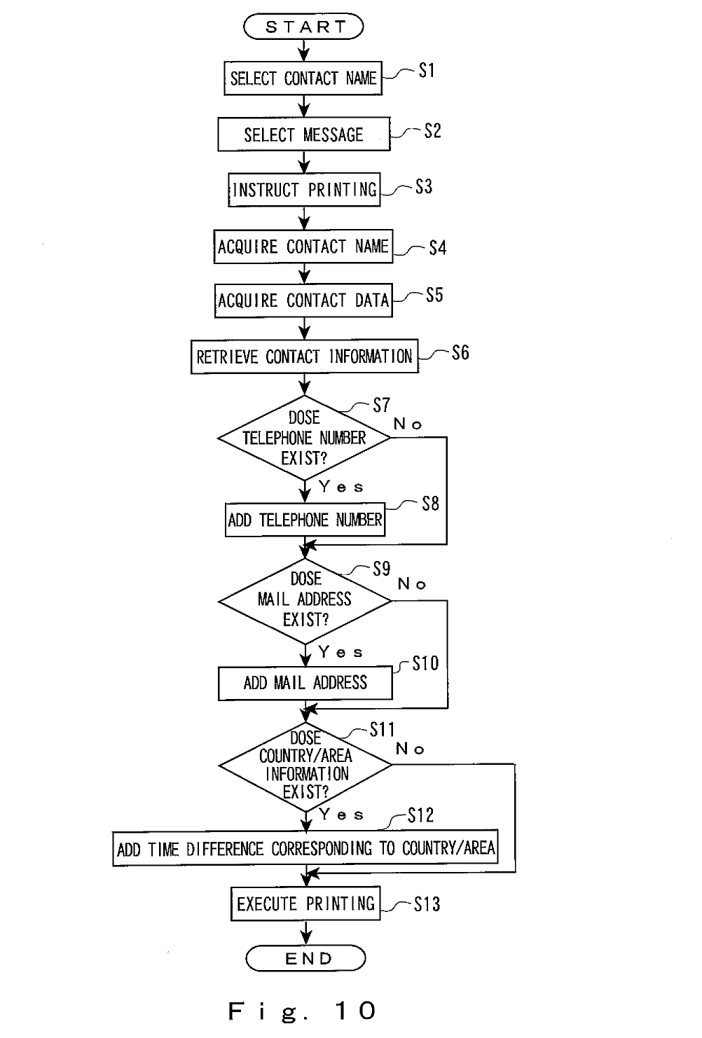

As shown in FIG. 9, when the printing operation is performed on the sticky note H1 on the basis of the selection, the telephone number 67 of the contact and a time difference 80 are automatically added and printed on the sticky note H1, in addition to the selected contact name 55, the current time 81, and the message 57. A portion “To Mike” is written in script. Hereinafter, a series of operations for automatically adding the contact information 56 such as the telephone or the like and performing the printing operation on the sticky note H1 will be described with reference to FIG. 10.

The application software 30 includes a contact acquiring device for acquiring the contact name 55, a message acquiring device for acquiring the message, and a contact information acquiring device for acquiring contact data from the storage unit of the personal computer on the basis of the contact name.

When the contact name 55 of the contact selection region 72 and the message 57 of the message selection region 74 are selected on the telephone memo preparation screen 71 (S1 and S2) and the print button 31 is clicked (S3), the application software 30 acquires the contact name 55 selected by the contact acquiring device (S4) and the contact data stored in the storage unit is acquired from the contact name acquired by the contact information acquiring device (S5). Thereafter, the application software 30 retrieves the contact information 56 such as the telephone number 67 from the acquired contact data (S6) and determines whether the telephone number 67 exists (S7). If the telephone number 67 has been input (registered) to the contact information, it is determined that the telephone number 67 exists and telephone number data is added to the print data printed on the sticky note H1 (S8). Meanwhile, if the telephone number 67 has not been input (registered) to the contact information, it is determined that the telephone number 67 does not exist and the telephone number data is not added to the print data. Similarly, it is determined whether the mail address 68 exists in the contact information 56 (S9). If so, mail address data is added to the print data (S10), and, if not, the mail address data is not added to the print data. It is determined whether the country/area of the contact has been input to the contact information 56 (S11). If so, the time difference 80 corresponding to the country/area is added (S12). When the printing operation is performed by the print unit assembly 12 on the basis of the print data having the contact information 56 (S13), the sticky note H1 having the contact information 56 can be obtained.

According to the above-described configuration, since a user inputs the contact name 55 and the message 57 such that the contact information 56 related to the contact name 55 is automatically added, it is possible to reduce the time and effort of the user required for inputting the contact information 56 related to the contact name 55. It is preferable that a common expression registration device for newly registering common expression data is provided, the category “Message” is selected, and the new preparation button 47 is clicked such that a new common expression can be registered. Accordingly, since the common expression which is in general use can be newly registered, it is possible to improve general versatility of the application software 30. Although the sticky note bundle H is used as the bundle of paper sheets in the present embodiment, the bundle of paper sheets is not limited to the bundle of sticky notes and a memo pad may be used.

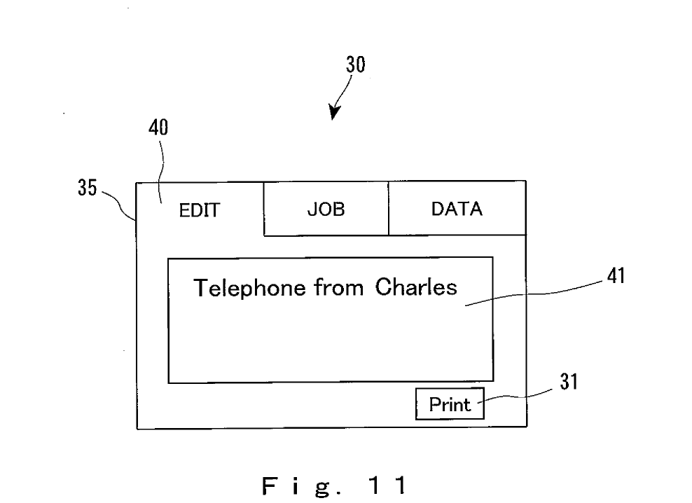

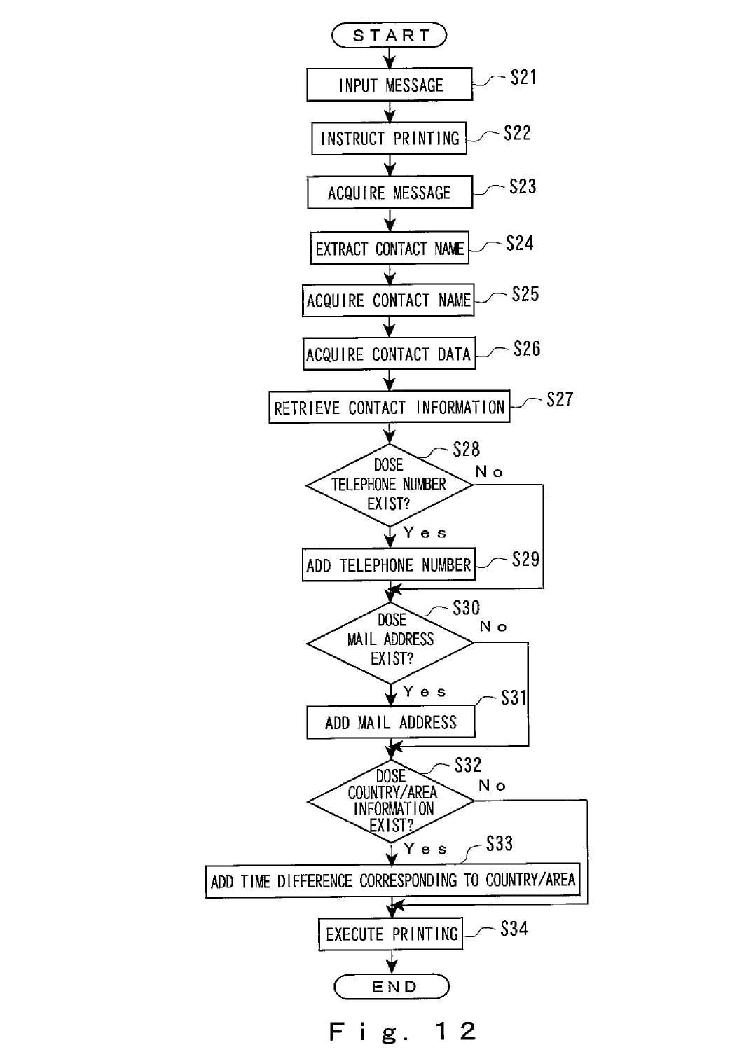

Next, a sticky note print system 1 according to a second embodiment of the invention will be described with reference to FIG. 11 and FIG. 12. In order to avoid duplicated description, only different portions will be described. The application software 30 of the sticky note print system 1 has a contact name extraction device for extracting the contact name 55 from the message 57 including the contact name 55 input by the keyboard 6. The contact name extraction device searches the message 57 and extracts the contact name 55 on the basis of the contact name 55 of the contact data stored in the storage unit of the personal computer.

In more detail, on the EDIT screen 35, when the message 57 including the contact name is prepared in the message input region 41 (S21) and the print button 31 is clicked (S22), the message 57 is acquired by the message acquiring device (S23). Thereafter, the contact name 55 is extracted from the acquired message 57 by the contact name extraction device (S24) and the contact data is acquired by the contact information acquiring device on the basis of the extracted acquired contact name 55 (S25 and S26).

Next, the application software 30 retrieves the contact information 56 such as the telephone number from the acquired contact data (S27) and determines whether the telephone number exists (S28). When the telephone number is input (registered) to the contact data, it is determined that the telephone number exists and telephone number data is added to the print data printed on the sticky note H1 (S29). Meanwhile, if the telephone number is not input (registered) to the contact information, it is determined that the telephone number does not exist and the telephone number data is not added to the print data. Similarly, it is determined whether the mail address exists in the contact information 56 (S30). If so, mail address data is added to the print data (S31), and, if so not, the mail address data is not added to the print data. It is determined whether the country/area of the contact is input to the contact information 56 (S32). If so, the time difference corresponding to the country/area is added (S33). When the printing operation is performed by the print unit assembly 12 on the basis of the print data having the contact information 56 (S34), the sticky note H1 having the contact information 56 can be obtained.

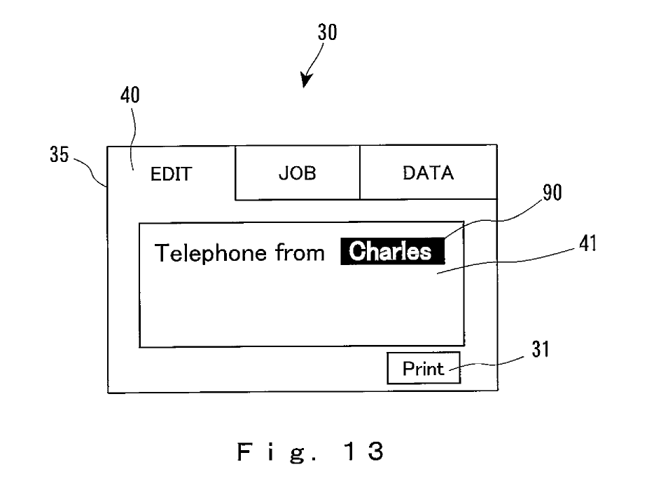

According to the above-described configuration, since the message 57 is input such that the contact information 56 related to the contact name 55 is automatically added, it is possible to reduce the time and effort of the user required for inputting the contact information 56 related to the contact name 55. Although the contact extraction device searches the entire message 57 in the second embodiment, only the contact name 55 of the message may be specified as a range 90 and only the portion specified by the range may be searched, as shown in FIG. 13. Accordingly, since the number of searched words can be reduced, it is possible to reduce time and effort required for a searching process.

What is claimed is:

1. A paper bundle print system for lifting up and separating paper sheets from a bundle of paper sheets one by one and performing a printing operation on the paper sheet, the paper bundle print system comprising:
a message acquiring device which acquires a message including a contact name;
a storage device which stores the contact name and contact information related to the contact name;
a contact name extraction device which extracts the contact name from the message;
a contact information acquiring device which acquires the contact information by comparing the extracted contact name with contents of the storage device; and
a print device which adds the acquired contact information to the message and performs a printing operation on the paper sheet.

2. A paper bundle print system for lifting up and separating paper sheets from a bundle of paper sheets one by one and performing a printing operation on the paper sheet, the paper bundle print system comprising:
a contact acquiring device which acquires a contact name;
a message acquiring device which acquires a message;
a storage device which stores the contact name and contact information related to the contact name;
a contact information acquiring device which acquires the contact information from the storage device on the basis of the acquired contact name; and
a print device which adds the acquired contact information and the contact name to the message and performs a printing operation on the paper sheet.

3. The paper bundle print system according to claim 1, wherein the contact information includes at least one of a telephone number, a mail address, an address, a time difference between a local time of the address and a current time of the printing operation on the paper sheet.

4. The paper bundle print system according to claim 1, further comprising:
a common expression storage device which stores a plurality of common expressions relating to the message; and
a common expression selection device which selects at least a desired common expression from the common expression storage device.

5. The paper bundle print system according to claim 4, further comprising a common expression registration device which registers a new common expression in the common expression storage device.

6. The paper bundle print system according to claim 1, further comprising:
a paper bundle printer including the print device; and
a computer including the message acquiring device, the storage device, the contact name extraction device and the contact information acquiring device.

7. The paper bundle print system according to claim 2, further comprising:
a paper bundle printer including the print device; and
a computer including the contact acquiring device, the message acquiring device, the storage device, and the contact information acquiring device.

8. A paper bundle printer comprising all the devices of the paper bundle print system according to claim 1.
